(19) United States
(12) Patent Application Publication
(10) Pub. No.: US 2021/0172675 A1
(43) Pub. Date: Jun. 10, 2021

(54) NOZZLE STRUCTURE FOR A QUICK FREEZER

(71) Applicant: Shanghai Ocean University, Shanghai (CN)

(72) Inventors: Jing XIE, Shanghai (CN); Jinfeng WANG, Shanghai (CN); Dazhang YANG, Shanghai (CN)

(21) Appl. No.: 16/820,568

(22) Filed: Mar. 16, 2020

(30) Foreign Application Priority Data
Dec. 10, 2019 (CN) 201911255793.0

(51) Int. Cl. F25D 25/04; A23L 3/36

(52) U.S. Cl. CPC F25D 25/04; A23V 2002/00; F25D 2400/30; A23L 3/36

(57) ABSTRACT

The invention discloses a nozzle structure for a quick freezer, including a plurality of conical diversion channels, a plurality of jet channel, a plurality of hemispherical nozzles and a steel belt. The nozzle structure is a funnel-shaped structure formed by the conical diversion channel, the jet channel and the hemispherical nozzle. The nozzle structure of the present invention can effectively improve flow area at the cross-flow direction, and a fluid buffer area is formed between two adjacent nozzles, which can reduce the cross-flow effect, and improve the heat exchange rate of the surface of the steel belt, thereby reducing the freezing time of food, improving the freezing efficiency of the quick freezer, and reducing the energy consumption.

### CROSS-REFERENCE TO RELATED APPLICATIONS

This application claims the benefit of priority from Chinese Patent Application No. 201911255793.0, filed on Dec. 10, 2019. The content of the aforementioned application, including any intervening amendments thereto, is incorporated herein by reference in its entirety.

### TECHNICAL FIELD

The present application relates to quick-freezing food machinery, particularly to a nozzle structure for a quick freezer having a structure similar to a shower head for improving the performance of a quick freezer.

### BACKGROUND

Since there are higher requirements for the quality of quick-frozen food, blast freezers, as an efficient food-freezing device, have been widely used in the food freezing industry. Circular orifice plate nozzles are commonly used as jet nozzles of the blast freezers. However, during the operation of the freezers, the cold air passing through the nozzles has a small sectional area along a cross-flow direction, leading to a relative large frictional drag and a cross-flow impact. As a result, non-uniform freezing temperature is created in freezing areas, which directly affects the quality of frozen food.

### SUMMARY

In order to overcome the defects of existing orifice plate nozzles of quick freezers, the present invention provides a nozzle structure for a quick freezer.

The present invention aims to design a novel nozzle structure, which can effectively increase the flow area of the cross flow, reduce the cross-flow effect, improve the heat exchange rate on the surface of the steel belt, thereby reducing the freezing time of food.

Specifically, provided is a nozzle structure for a quick freezer, comprising a plurality of conical diversion channels, a plurality of jet channels, a plurality of hemispherical nozzles and a steel belt; the conical diversion channels are arranged in a linear arrangement, and a distance between two adjacent conical diversion channels is 60-100 mm; a bottom of each conical diversion channel is a circle having a diameter of 45-55 mm; a height of the conical diversion channel is 20-30 mm, and a wall thickness of the conical diversion channel is 1-3 mm; a diameter of a throat of the jet channel is 30-40 mm; a height of the jet channel is 20-30 mm, and a wall thickness of the jet channel is 1-3 mm; a diameter of each hemispherical nozzle is 10-20 mm, and a wall thickness of the hemispherical nozzle is 1-3 mm; each hemispherical nozzle comprises a plurality of peripheral nozzle holes and a central nozzle hole; an angle between a center line of each peripheral nozzle hole and a center line of the central nozzle hole is 40-50°; the steel belt is located under the hemispherical nozzle, and a vertical distance between an outlet of the hemispherical nozzle and the steel belt is 10-50 mm.

In some embodiments, the distance between two adjacent conical diversion channels is 70-90 mm; the bottom of the conical diversion channel is a circle having a diameter of 40 mm; and a height of the conical diversion channel is 25 mm, and a wall thickness of the conical diversion channel is 2 mm; the diameter of the throat of the jet channel is 35-45 mm; the height of the jet channel is 25 mm, and a wall thickness of the jet channel is 2 mm; the diameter of the hemispherical nozzle is 15 mm, and a wall thickness of the hemispherical nozzle is 2 mm; each hemispherical nozzle comprises comprising the peripheral nozzle holes and the central nozzle hole; the angle between the center line of each of the peripheral nozzle holes and the center line of the central nozzle hole is 45°; the steel belt is located under the hemispherical nozzle, and the vertical distance between the outlet of the hemispherical nozzle and the steel belt is 20-40 mm.

In some embodiments, the distance between two adjacent conical diversion channels is 80 mm; the circle of the conical diversion channel is a circle having a diameter of 50 mm; the height of the conical diversion channel is 25 mm, and a wall thickness of the conical diversion channel is 2 mm; the diameter of the throat of the jet channel is 40 mm; the height of the jet channel is 25 mm and a wall thickness of the jet channel is 2 mm; the diameter of the hemispherical nozzle is 15 mm, and the wall thickness of the hemispherical nozzle is 2 mm; each hemispherical nozzle comprises the peripheral nozzle holes and the central nozzle hole, and the angle between the center line of each of the peripheral nozzle holes and the central nozzle hole is 45°; the steel belt is located under the hemispherical nozzle, and the vertical distance between the outlet of the hemispherical nozzle and the steel belt is 30 mm.

The novel nozzle structure of the quick freezer of the present invention can effectively increase the cross-flow area, reduce the cross-flow effect, increase the heat exchange rate on the surface of the steel belt, and reduce the freezing time of food.

### BRIEF DESCRIPTION OF THE DRAWINGS

FIG. 1 is a schematic diagram of a nozzle structure according to the present invention;

FIG. 2 is a perspective view from bottom of the nozzle structure according to the present invention, in which the steel belt is not shown;

FIG. 3 is a front view of the nozzle structure;

FIG. 4 is a top view of a nozzle;

FIG. 5 is a front view of the nozzle;

FIG. 6 is a sectional view of a hemispherical nozzle;

FIG. 7 shows a distribution of a velocity range at the nozzle outlets when the diameter of the throat of the jet channel changes;

FIG. 8 shows a distribution of the average Nusselt number on the surface of the steel belt when the diameter of the throat of the jet channel changes;

FIG. 9 shows a distribution of the velocity range at the nozzle outlets when the diameter of the nozzle hole changes; and

FIG. 10 shows a distribution of the average Nusselt number on the surface of the steel belt when the diameter of the nozzle hole changes.

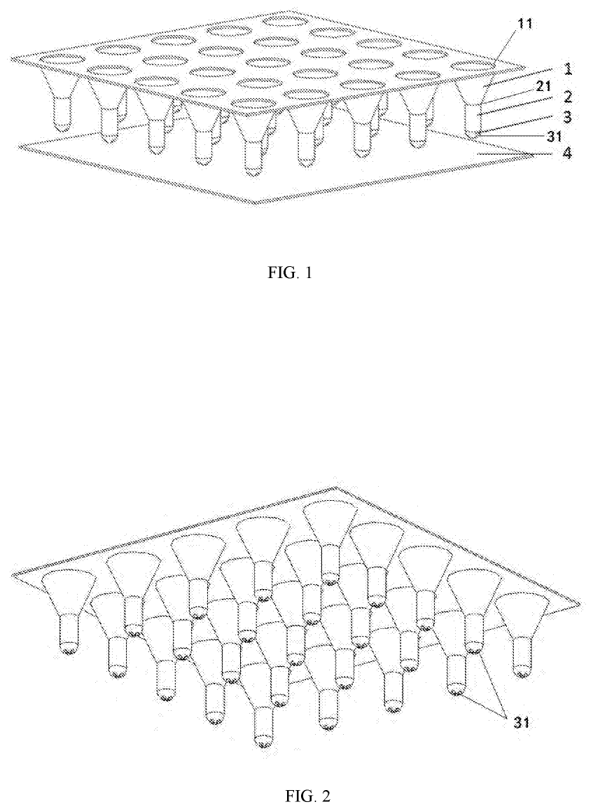

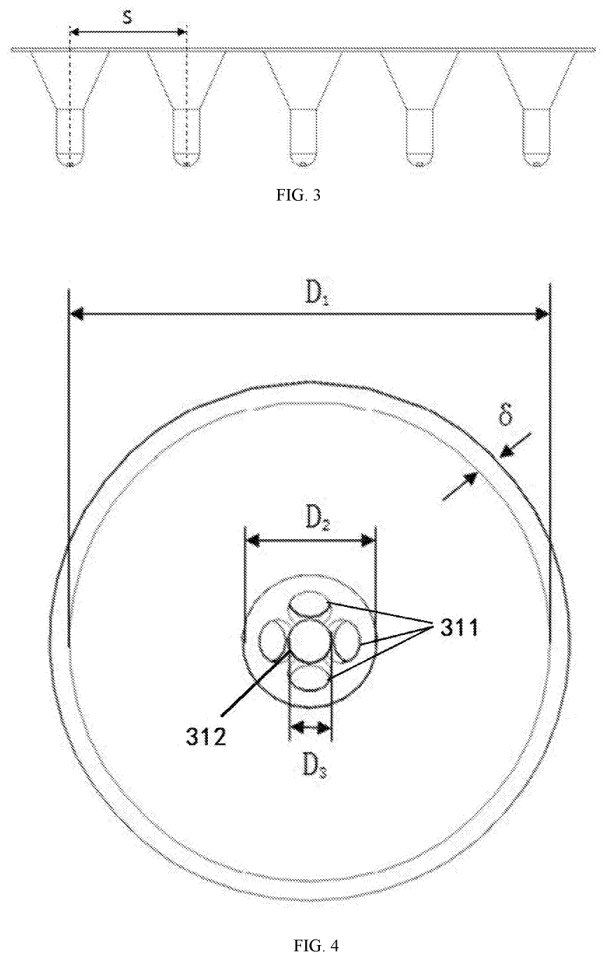

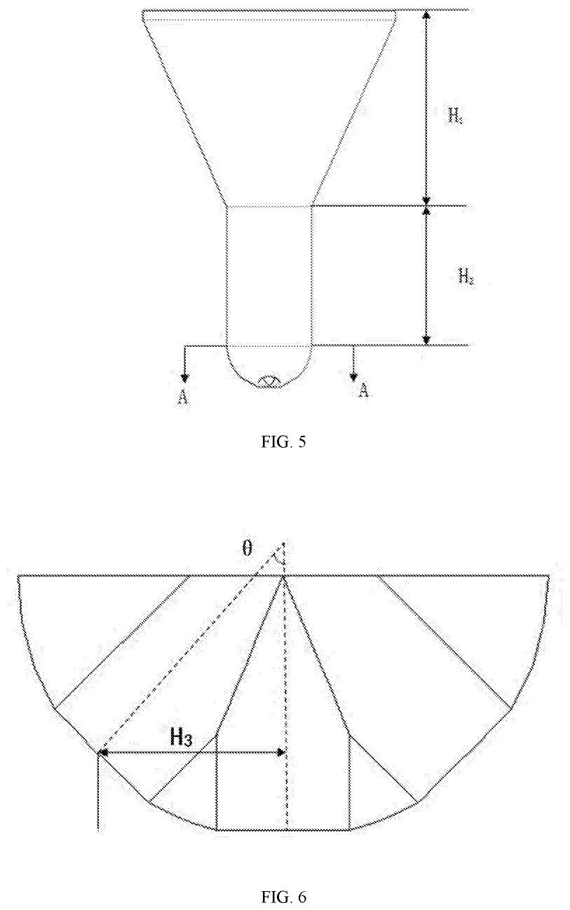

In the drawings: 1, conical diversion channel; 2, jet channel; 3, hemispherical nozzle; 4, steel belt; 11, bottom; 21, throat; 31, nozzle hole; 311, peripheral nozzle hole; 312, central nozzle hole.

### DETAILED DESCRIPTION OF EMBODIMENTS

The present invention is further illustrated as follows with reference to the accompanying drawings, from which the operation process and characteristics of the present invention will be easy to be understood.

This embodiment illustrates a nozzle structure for a quick freezer, comprising a plurality of conical diversion channels 1, a plurality of jet channels 2, a plurality of hemispherical nozzles 3, and a steel belt 4. The conical diversion channels 1 are arranged in a linear arrangement, and a distance S between two adjacent conical diversion channels 1 is 80 mm; δ is a thickness of the nozzle structure; a bottom 11 of the conical diversion channel 1 is a circle having a diameter D₁ of 50 mm, and a height H₁ of the conical diversion channel is 25 mm and a wall thickness of the conical diversion channel is 2 mm. A diameter D₂ of the throat 21 of the jet channel 2 is 40 mm, and a height H₂ of the jet channel is 25 mm, and a wall thickness of the jet channel is 2 mm. A diameter of each hemispherical nozzle 3 is 15 mm, and a wall thickness of the hemispherical nozzle is 2 mm, and each hemispherical nozzle comprises five nozzle holes 31 comprising peripheral nozzle holes 311 and a central nozzle hole 312. D₃ is a diameter of each nozzle hole. An angle θ between a center line of each peripheral nozzle hole 311 and a center line of the central nozzle hole 312 is 45°.

The steel belt 4 is located under the hemispherical nozzles 3, and a vertical distance between an outlet of the nozzle structure and the steel belt is 30 mm. One end of the jet channel 2 having the throat 21 is connected with one end of the conical diversion channel 1 far away from the bottom of the conical diversion channel, and the other end of the jet channel 2 is connected with an end of the hemispherical nozzle 3 having a cross section of the hemispherical nozzle of a larger diameter.

An impacting freezing test bench is used as a model in this embodiment. The size of the plenum chamber is 400*400*600 mm, and the size of the orifice plate is 400*400*2 mm. FIG. 1 is a schematic diagram of a nozzle structure for a quick freezer. The nozzle structure includes the conical diversion channels, the jet channels and the hemispherical nozzles. Each hemispherical nozzle has five nozzle holes, and the central nozzle hole 312 is perpendicular to a surface of the steel belt, and an angle θ is formed between each peripheral nozzle hole 311 and the central nozzle hole 312. In this embodiment, air is used as the fluid, and the following assumptions are made: (1) air is an incompressible fluid; (2) during normal operation of the model, the internal flow field is in a steady state; (3) the wall of the plenum chamber is thermal-insulating. A k−ε turbulence model is used in the model. Due to the temperature change during the impacting, the energy equation is used. The pressure inlet boundary condition is Pᵢₙ=250 Pa, and the pressure outlet boundary condition is Pₒᵤₜ=0 Pa. The inlet temperature of the frozen area is set to 230 K and the outlet temperature of the frozen area is set to 235 K. The conveyor belt is treated as the steel belt, and the thermal conductivity thereof is 16.3 W/(m*° C.).

1. The diameter D₂ of the throat 21 of the jet channel 2 is changed while other structural parameters of the nozzle structure for the quick freezer remain unchanged.

Research shows that the position under the nozzle hole 31 has the highest heat transfer coefficient. When the diameter D₂ of the throat 21 is smaller, the distribution of Nusselt number at the surface of the steel belt is more concentrated. As the diameter of the throat 21 increases, the distribution of Nusselt number at the surface of the steel belt 4 becomes more and more dispersed, and the heat transfer coefficients of positions under the inclined peripheral nozzle holes 311 become smaller and smaller.

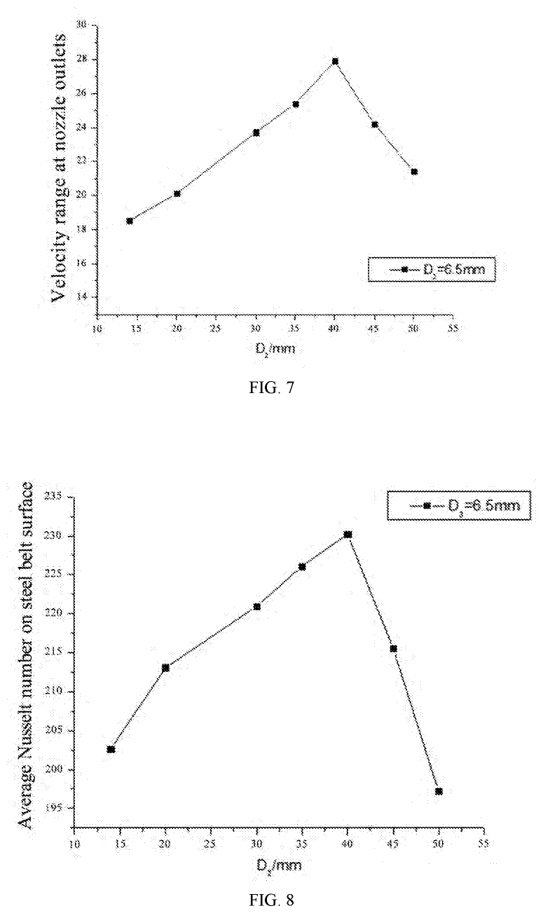

FIG. 7 shows a distribution of velocity range at the nozzle outlets with different diameters D₂ of the throat of the jet channel. It can be seen that when the diameter D₂ of the throat 21 increases while the inclination angle of the peripheral nozzle holes 311 remains unchanged, a straight-line distance H₃ between a center of an outlet of the peripheral nozzle hole 311 and a center line of the central nozzle hole 312 increases, and the distribution of the velocity range of the five nozzle holes 31 becomes more and more dispersed. When the diameter D₂ of the throat 21 is appropriately increased, the acting area of the impacting jet on the internal flow field increases, so the velocity at the outlet of the hemispherical nozzle 3 increases, resulting in an increase in the average Nusselt number on the surface of the steel belt 4, thereby enhancing a heat exchange effect on the surface of the steel belt 4.

As the diameter D₂ of the throat 21 continues to increase, the distribution of the velocity range of the five nozzle holes 31 becomes more and more dispersed, and the force of the jet impacting on the internal flow field is dispersed, so that the advantages of the jet impacting is not shown, causing the velocity at the outlet of the hemispherical nozzle 3 to decrease. Therefore, the average Nusselt number on the surface of the steel belt 4 is reduced, and the heat exchange effect on the surface of the steel belt 4 is reduced.

FIG. 8 shows a distribution of the average Nusselt number on the surface of the steel belt with different diameters D₂ of the throat of the jet channel. It can be seen that the average Nusselt number on the surface of the steel belt 4 reaches the maximum value when D₂=40 mm, while other structural parameters of the nozzle structure for the quick freezer remain unchanged.

2. The diameter D₃ of the nozzle hole 31 of the hemispherical nozzle 3 is changed while other structural parameters of the nozzle structure for the quick freezer remain unchanged.

Based on the numerical simulation, it is found that when the diameter D₃ of the nozzle hole 31 is small, the distribution of the Nusselt number on the surface of the steel belt 4 is concentrated. With the increase of the diameter of the nozzle hole 31, the Nusselt number in the upstream area (that is, the left side area) of the surface of the steel belt 4 decays, and the heat transfer peak of the jet center gradually moves downstream.

FIG. 9 shows a distribution of velocity range at the outlet of the hemispherical nozzle 3 with different diameters D₃ of the nozzle holes 31. It can be seen that proper increasing in the diameter D₃ of the nozzle hole will increase the mass flow rate of the impacting jet, so the Nusselt number on the surface of the steel belt 4 will increase, resulting in a better heat transfer effect. As the diameter D₃ of the nozzle holes 31 continues to increase, the upstream area away from the pressure outlet will have a greater frictional drag, and the outlets of the nozzle holes 31 have a lower velocity. As a result, the Nusselt number on the surface of the steel belt 4 will be smaller, resulting in a poor heat transfer effect.

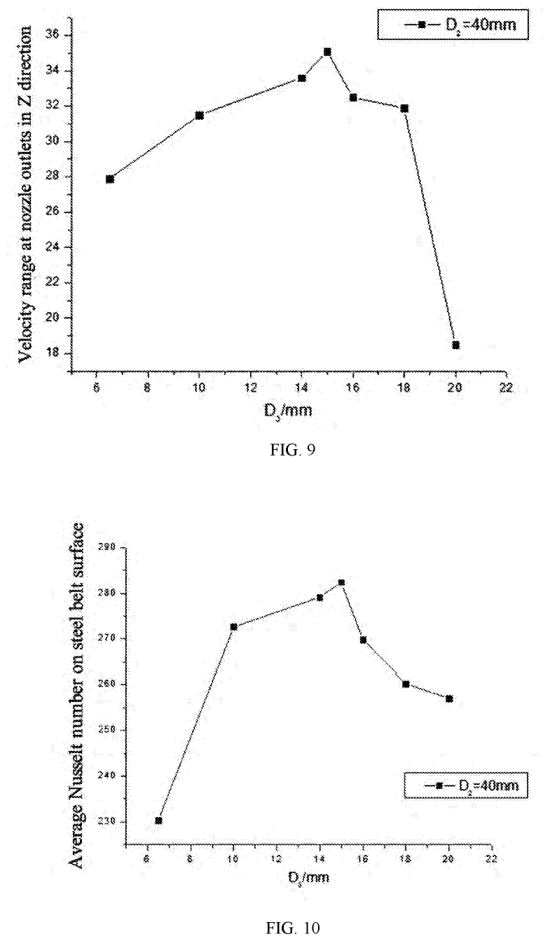

FIG. 10 shows the distribution of the average Nusselt number on the surface of the steel belt with different diameters D₃ of the nozzle holes 31. It can be concluded that the average Nusselt number on the surface of the steel belt has the maximum value when D₃=15 mm under the condition that other structural parameters of the nozzle structure for the quick freezer remain unchanged.

Numerical simulation is carried out for the frozen area of the quick freezer, and the simulation results show that: with the same outlet area of the hemisphrical nozzle 3, the average Nusselt number on the surface of the steel belt 4 of the hemisperical nozzle 3 of the quick freezer is 282.39. The average Nusselt number of positions under the conventional circular nozzle on flat profile plates is 255.64. It can be seen that the average Nusselt number of the nozzle structure of the quick freezer has increased by about 10.4% compared with the conventional circular nozzle. Such structure can greatly increase the flow area at the cross-flow direction and reduce the cross-flow effect.

The present invention provides the nozzle structure for the quick freezer, which can effectively increase the flow area at the cross-flow direction, reduce the cross-flow effect, increase the heat exchange rate on the surface of the steel belt, and reduce the freezing time of food.

The above-mentioned embodiment is only intended to illustrate the principle and uses of the present invention, and its description is more specific and detailed, but it cannot be understood as limiting the scope of the patent of the present disclosure. It should be pointed out those of ordinary skill in the art may further make a plurality of variations and improvements without departing from the concept of the present invention, and these all pertain to the protection scope of the present invention. Therefore, all equivalent modifications or changes made by those ordinary skill without departing from the spirit and technical ideas of the present invention shall fall within the scope of the appended claims of the present invention.

What is claimed is:

1. A nozzle structure for a quick freezer, comprising a plurality of tapered diversion channels, a plurality of jet channels, a plurality of hemispherical nozzles and a steel belt;
wherein the conical diversion channels are arranged in a linear arrangement, and a distance between two adjacent conical diversion channels is 60-100 mm;
a bottom of each conical diversion channel is a circle having a diameter of 45-55 mm, a height of the conical diversion channel is 20-30 mm, and a wall thickness of the conical diversion channel is 1-3 mm;
a diameter of a throat of each jet channel is 30-40 mm, a height of the jet channel is 20-30 mm, and a wall thickness of the jet channel is 1-3 mm; a diameter of each hemispherical nozzle is 10-20 mm, and a wall thickness of the hemispherical nozzle is 1-3 mm; each hemispherical nozzle comprises a plurality of peripheral nozzle holes and a central nozzle hole, and an angle between a center line of each peripheral nozzle hole and a center line of the central nozzle hole is 40-50°; the steel belt is located under the hemispherical nozzles, and a vertical distance between an outlet of the hemispherical nozzle and the steel belt is 10-50 mm.

2. The nozzle structure of claim 1, wherein the distance between two adjacent conical diversion channels is 70-90 mm; the bottom of the conical diversion channel is a circle having a diameter of 50 mm; the height of the conical diversion channel is 25 mm; and the wall thickness of the conical diversion channel is 2 mm; the diameter of the throat of the jet channel is 35-40 mm; the height of the jet channel is 25 mm; and the wall thickness of the jet channel is 2 mm; the diameter of the hemispherical nozzle is 15 mm, and a wall thickness of the hemispherical nozzle is 2 mm; each hemispherical nozzle comprises 5 nozzle holes; the angle between the center line of each peripheral nozzle hole and the center line of the central nozzle hole is 45°; the steel belt is located under the hemispherical nozzles, and the vertical distance between the outlet of the hemispherical nozzle and the steel belt is 20-40 mm.

3. The nozzle structure of claim 1, wherein the distance between two adjacent conical diversion channels is 80 mm; the diameter of the throat of the jet channel is 40 mm; the height of the jet channel is 25 mm; and the wall thickness of the jet channel is 2 mm; the steel belt is located under the hemispherical nozzle, and the vertical distance between the outlet of the hemispherical nozzle and the steel belt is 30 mm.
